(19) United States
(12) Patent Application Publication
(10) Pub. No.: US 2009/0253434 A1
(43) Pub. Date: Oct. 8, 2009

(54) Base Station And Method For Reducing Transfer Delay

(76) Inventors: Ritsuo HAYASHI, Kawasaki (JP); Yoshiko Koizumi, Kawasaki (JP)

Correspondence Address: HANIFY & KING PROFESSIONAL CORPORATION, 1055 Thomas Jefferson Street, NW, Suite 400, WASHINGTON, DC, 20007, US

(21) Appl. No.: 12/486,534

(22) Filed: Jun. 17, 2009

Related U.S. Application Data
(63) Continuation of application No. PCT/JP2007/055762, filed on Mar. 20, 2007.

(51) Int. Cl. H04W 36/00; H04B 1/38

(52) U.S. Cl. 455/436; 455/561

(57) ABSTRACT

A disclosed base station for transferring, to a user terminal, a series of packet data received from a higher-level network, includes a determining unit configured to, when the user terminal is handed over to a handover destination base station due to movement of the user terminal, determine according to a transfer delay-related characteristic of the series of packet data whether data forwarding of the series of the packet data to the handover destination base station is not to be performed.

### CROSS-REFERENCE TO RELATED APPLICATIONS

The present application is a continuation application filed under 35 U.S.C. 111 (a) claiming benefit under 35 U.S.C. 120 and 365 (c) of PCT International Application No. PCT/JP2007/055762, filed on Mar. 20, 2007, the entire contents of which are incorporated herein by reference.

### FIELD

The present disclosure is directed to a base station used in a network of wireless communications devices, such as mobile phones, a handover processing method used by base stations, and a computer program for executing the handover processing method. In particular, the present disclosure is directed to a base station and a handover processing method capable of reducing transfer delay related to a handover procedure, a computer program for causing a computer to execute such a handover processing method, and a computer-readable recording medium for storing such a program.

### BACKGROUND

With the wide use of the Internet, communications services using IP (Internet Protocol) packets have exploded, centering around mobile phones. In the course of the explosive growth, various applications have come to be provided as IP packet-based services. It is important for users to enjoy such services without regard to being in motion.

FIG. 1 is a sequence diagram showing a handover procedure in a 3G LTE (Long Term Evolution) packet network. The handover procedure is described in a 3GPP specification (Non-patent Document 1) as follows.

A base station (Source e-Node B) 121 transmits a measurement control message (Measurement Control) to a user terminal (UE) 110 as an L3 signal (Step S1). At this point, packet data are transmitted from a core network apparatus (EPC, Evolved Packet Core) 130 to the user terminal 110 via the base station 121. The base station 121 transmits an up-link allocation message (UL Allocation) to the user terminal 110 as an L1/L2 signal so as to allocate an uplink channel. The user terminal 110 transmits a measurement report message (Measurement Report) to the base station 121 in order to report a signal communication condition of the user terminal 110.

The base station (Source e-Node B) 121 determines based on the communication condition reported by the user terminal 110 whether handover to another base station (Target e-Node B) 122 due to movement of the user terminal 110 is necessary. When the base station 121 determines that handover is necessary (Step S3), the handover source base station (Source e-Node B) 121 transmits a handover request message to the base station (Target e-Node B) 122, which is a handover destination candidate (Step S4).

The handover request message includes tunnel configuration information used to configure a data-forwarding tunnel. The data-forwarding tunnel is used to send forward to the base station 122 packet data (1 through 4 of FIG. 2) that have been transmitted to the handover source base station 121 from the core network apparatus (EPC) 130 after implementation of handover is decided. That is, the data-forwarding tunnel is a temporary data-forwarding packet transfer path established between the handover source base station and the handover destination base station. The packet data (1 through 4 of FIG. 2) transmitted from the core network apparatus 130 to the handover source base station 121 after implementation of handover is decided are sent forward to the base station 122 via the tunnel, and then transmitted from the base station 122 to the user terminal 110. In this manner, the packet data are not lost.

The base station 122 becomes a handover destination base station by performing call admission control (Admission Control) (Step S5) and sending a handover request acknowledge message (Handover Request Acknowledge) back to the handover source base station 121 (Step S6).

On receiving the handover request acknowledge message from the handover destination base station 122 (Step S6), the handover source base station 121 sends a down-link allocation message (DL Allocation) to the user terminal 110 as an L1/L2 signal and then transmits a handover command message (Handover Command) to the user terminal 110 so that the user terminal 110 performs communications in sync with the handover destination base station 122 (Step S7).

The handover source base station 121 forwards to the handover destination base station 122 the packet data that have been sent from the higher-level core network apparatus (EPC, Evolved Packet Core) 130 (DL Data Forwarding) (Step S8).

The user terminal 110 synchronizes with the handover destination base station 122 based on the L1/L2 signal (Synchronization), and receives an up-link allocation message (UL Allocation) and a timing advance message (Timing Advance). Upon becoming ready to receive packet data from the handover destination base station 122, the user terminal 110 transmits a handover confirmation message (Handover Confirm) to the handover destination base station 122 (Step S9). At this point, since the core network apparatus 130 does not know that the user terminal 110 has been handed over to the handover destination base station 122, packet data directed to the user terminal 110 are still transmitted to the handover source base station 121.

After receiving the handover confirm message from the user terminal 110 (Step S9), the handover destination base station 122 transmits a handover completion message (Handover Complete) to the higher-level core network apparatus 130 so as to report to the core network apparatus 130 that the user terminal 110 has come to belong to the handover destination base station 122 (Step S10).

In response, the core network apparatus 130 switches a communications path (Step S11) so as to change the transmission destination of packet data directed to the user terminal 110 from the handover source base station 121 to the handover destination base station 122. The core network apparatus 130 transmits a handover completion acknowledgement message (Handover Complete Acknowledge) to the handover destination base station 122. In response, the handover destination base station 122 transmits a release resource message (Release Resource) to the handover source base station 121 (Step S13) so that the handover source base station 121 releases resources allocated for the user terminal 110. At this point, if the handover source base station 121 still has packet data directed to the user terminal 110, the handover source base station 121 keeps forwarding the packet data to the handover destination base station 122 (Step S14), and then releases resources for the user terminal 110 after all the packet data directed to the user terminal 110 are sent (Step S15).

After the communications path switching (Step S11), packet data directed to the user terminal 110 are transmitted to the user terminal 110 from the core network apparatus 130 via the handover destination base station 122.

FIG. 2 illustrates in further detail the packet data transfer to the user terminal of FIG. 1. The user terminal (UE) 110, the handover source base station (Source e-Node B) 121, the handover destination base station (Target e-Node B) 122, and the core network apparatus (EPC) 130 of FIG. 2 correspond to the user terminal (UE) 110, the handover source base station (Source e-Node B) 121, the handover destination base station (Target e-Node B) 122, and the core network apparatus (EPC) 130 of FIG. 1, respectively.

As the user terminal 110 moves, the user terminal 110 is handed over from the handover source base station 121 to the handover destination base station 122. At this point, the handover source base station 121 transmits a handover request message (Handover Request) 251 to the handover destination base station 122 (Step S4 of FIG. 1). The handover destination base station (Target e-Node B) 122 sends back a handover request acknowledge message (Handover Request Acknowledge) 252 to the handover source base station 121 (Step S6 of FIG. 1).

The handover request message 251 includes tunnel configuration information required to configure a tunnel used for data forwarding 253. The data-forwarding tunnel 253 is used to send forward to the handover destination base station 122 packet data (1 through 4) that have been transmitted to the handover source base station 121 from the core network apparatus 130 after implementation of handover is decided. That is, the data-forwarding tunnel 253 is a temporary data-forwarding packet transfer path established between the handover source base station and the handover destination base station. The packet data (1 through 4) transmitted from the core network apparatus 130 to the handover source base station 121 after implementation of handover is decided are sent forward to the handover destination base station 122 via the tunnel, and then transmitted from the handover destination base station 122 to the user terminal 110.

After handover is implemented, the core network apparatus 130 switches a communications path (Step S11 of FIG. 1), and transmits subsequent packet data (5 through 7 of FIG. 2) to the handover destination base station 122.

Here, the numbers of the packet data (1 through 7) indicate the sequence of packet data transmitted from the core network apparatus 130 to the base station 121 or 122, and also indicate the sequence of packet data transmitted from the base station 121 or 122 to the user terminal 110.

Even if having received the packet data 5 through 7 from the core network apparatus 130, the handover destination base station 122 waits to receive the packet data 1 through 4 forwarded from the handover source base station 121. Then, the handover destination base station 122 first transmits the packet data 1 through 4 to the user terminal 110, and subsequently transmits to the user terminal 110 the packet data 5 through 7 directly received from the core network apparatus 130.

[Non-patent Document 1] 3GPP TS 36.300 V0.5.0 (2007-02)

In the case of services for which transfer delay is undesirable (for example, Voice over IP (VoIP) service), it is sometimes the case that not performing data forwarding from the handover source base station to the handover destination base station is preferable in the interest of QoS (Quality of Service).

However, the conventional handover procedure does not have means to report that no data forwarding is to be performed from the handover source base station to the handover destination base station. Accordingly, the handover destination base station waits for preceding packet data to be forwarded from the handover source base station (in order to transfer the packet data to the user terminal prior to sending packet data received from the core network apparatus). Therefore, even if subsequent packets have been directly transmitted from the core network apparatus after communications path switching, the handover destination base station cannot immediately transmit the subsequent packets to the user terminal. This causes a delay in packet transfer.

In addition, even for services for which transfer delay is undesirable and, therefore, data forwarding is not required, the conventional handover procedure implements the process of configuring a tunnel used for data forwarding from the handover source base station to the handover destination base station. As a result, unnecessary workloads are applied to the base stations and the network between them. The tunnel configuration process may also contribute to transfer delay.

### SUMMARY

According to one aspect of the present disclosure, the base station for transferring, to a user terminal, a series of packet data received from a higher-level network, includes a determining unit configured to, when the user terminal is handed over to a handover destination base station due to movement of the user terminal, determine according to a transfer delay-related characteristic of the series of packet data whether data forwarding of the series of the packet data to the handover destination base station is not to be performed.

The object and advantages of the disclosure will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a sequence diagram illustrating handover and packet data transfer described in the 3G LTE;

FIG. 2 illustrates in further detail the packet data transfer of FIG. 1;

FIG. 3 is a flowchart illustrating the operation of a handover source base station according to the first embodiment of the present disclosure;

FIG. 4 is a flowchart illustrating the operation of a handover destination base station according to the first embodiment of the present disclosure;

FIG. 5 is a sequence diagram illustrating a handover procedure according to the first embodiment of the present disclosure;

FIG. 6 illustrates further in detail the packet data transfer in the handover procedure of FIG. 5, according to the first embodiment of the present disclosure;

FIG. 7 is a sequence diagram illustrating a handover procedure according to another embodiment of the present disclosure;

FIG. 8 illustrates packet data transfer in the handover procedure according to yet another embodiment of the present disclosure, and relates to the case in which a user terminal is using multiple services having different delay qualities;

FIG. 9 is a block diagram illustrating the configuration of a base station according to one embodiment of the present disclosure;

FIGS. 10A through 10C illustrate data formats of a handover request signal, with FIG. 10A illustrating a conventional data format presented for the purpose of comparison, FIG. 10B illustrating a data format according to one embodiment of the present disclosure, and FIG. 10C illustrating a data format according to another embodiment of the present disclosure;

FIG. 11 is a flowchart illustrating the operation of a handover source base station according to the second embodiment of the present disclosure; and

FIG. 12 is a sequence diagram illustrating a handover procedure according to the second embodiment of the present disclosure.

### DESCRIPTION OF EMBODIMENTS

In the handover process, the present invention performs control on services for which transfer delay is undesirable, which control is different from control performed on other services (i.e. services for which packet loss is less desirable than transfer delay—for example, video monitoring service). Herewith, the present invention is capable of reducing packet data transfer delay associated with handover and making breaks in application services less likely to occur.

Embodiments that describe the best mode for carrying out the present disclosure are explained next with reference to the drawings.

### First Embodiment

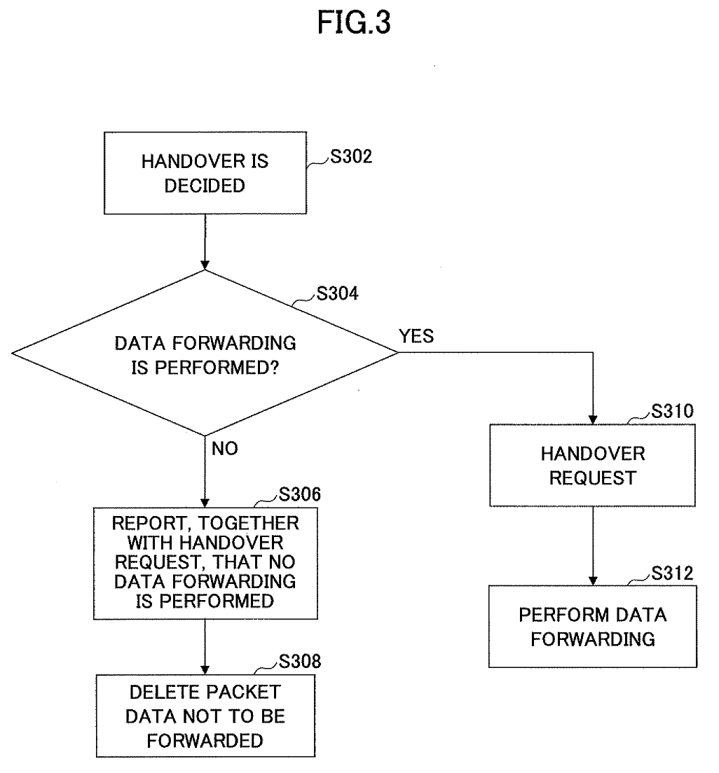

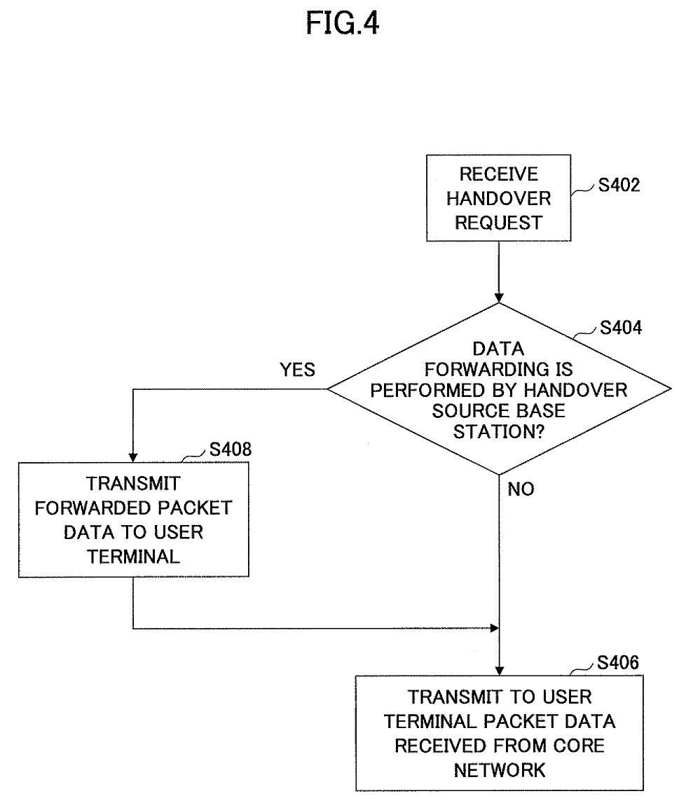

With reference to FIGS. 3 and 4, the operation of base stations is explained according to one embodiment of the present invention. FIG. 3 is a flowchart illustrating the operation of a handover source base station according to the first embodiment of the present disclosure, and FIG. 4 is a flowchart illustrating the operation of a handover destination base station according to the first embodiment.

When performing handover is decided (Step S302), the handover source base station according to one embodiment of the present disclosure determines whether to perform data forwarding, in accordance with a transfer delay-related characteristic of a service being used by the user of a user terminal (Step S304).

This determination is made by determining whether packet data that the base station is receiving from a core network apparatus and then transmitting to the user terminal are those related to a service for which transfer delay is undesirable. A “service for which transfer delay is undesirable” means a service for which some packet loss may be acceptable but packet transfer delay is undesirable in order to maintain constant QoS. An example of such is VoIP (Voice over IP). A telecommunications carrier may decide whether a certain service is a service for which transfer delay is undesirable. Specifically, each base station receives in advance information on characteristics of individual services from the core network apparatus. The base station is given a report, for example, that transfer delay is undesirable for VoIP but packet loss should be prevented for video streaming and e-mail services. Based on the information and the service type reported regarding an IP flow, the base station is able to learn that packet data are, for example, for VoIP.

In the case where no data forwarding is to be performed (NO in Step S304), the handover source base station reports to the handover destination base station that no data forwarding is to be performed (Step S306). In this case, the handover source base station does not configure a tunnel for data forwarding. This report is made, for example, by including a parameter indicating that “data forwarding is/is not to be performed” in a handover process-related control message (e.g. handover request) transmitted from the handover source base station to the handover destination base station and transmitting the control message to the handover destination base station.

On the other hand, on receiving the control message (e.g. handover request) (Step S402 of FIG. 4), the handover destination base station determines, by decoding the parameter included in the control message, whether data forwarding is to be performed (Step S404). If determining that no data forwarding is to be performed, the handover destination base station transmits packet data received from the core network apparatus to the user terminal without waiting for tunnel configuration and data forwarding performed by the handover source base station (Step S406).

In the case where the service in use is not a “service for which transfer delay is undesirable” (YES in Step S304 of FIG. 3), the handover source base station determines to perform data forwarding as in the conventional technique, transmits a handover request (Step S310) and performs data forwarding (Step S312).

On the other hand, if the handover destination base station determines, by decoding the parameter included in the control message, that data forwarding is to be performed, the handover destination base station waits to receive data forwarded from the handover source base station, and transmits packet data received in the data forwarding to the user terminal (Step S408). Subsequently, the handover destination base station transmits packet data received from the core network apparatus to the user terminal (Step S406).

In Step S306, instead of transmitting, to the handover destination base station, the control message (e.g. handover request) that includes the parameter indicating that “data forwarding is/is not to be performed”, the handover source base station may perform control not to include the tunnel configuration information, which is usually included in the control message, only if no data forwarding is to be performed.

Based on the presence or absence of the tunnel configuration information in the control message, the handover destination base station determines whether data forwarding is to be performed by the handover source base station.

After reporting to the handover destination base station, together with the control message, that no data forwarding is to be performed (Step S306), the handover source base station deletes packet data that have been received from the core network apparatus but have yet to be transmitted to the user terminal (Step S308).

Sequence in the Case where Only VoIP is in Use

Next is described a sequence taken in the case of performing handover when the user is using only VoIP, which is an application for which transfer delay is undesirable.

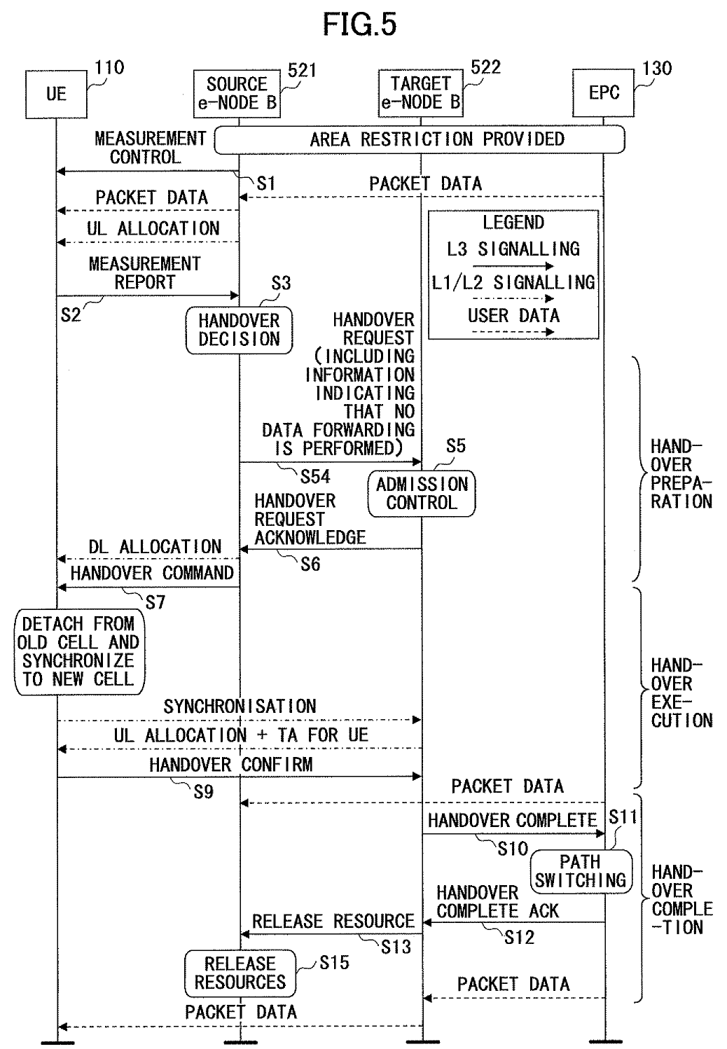

FIG. 5 is a sequence diagram illustrating a handover procedure carried out when no data forwarding is performed, according to the first embodiment of the present disclosure.

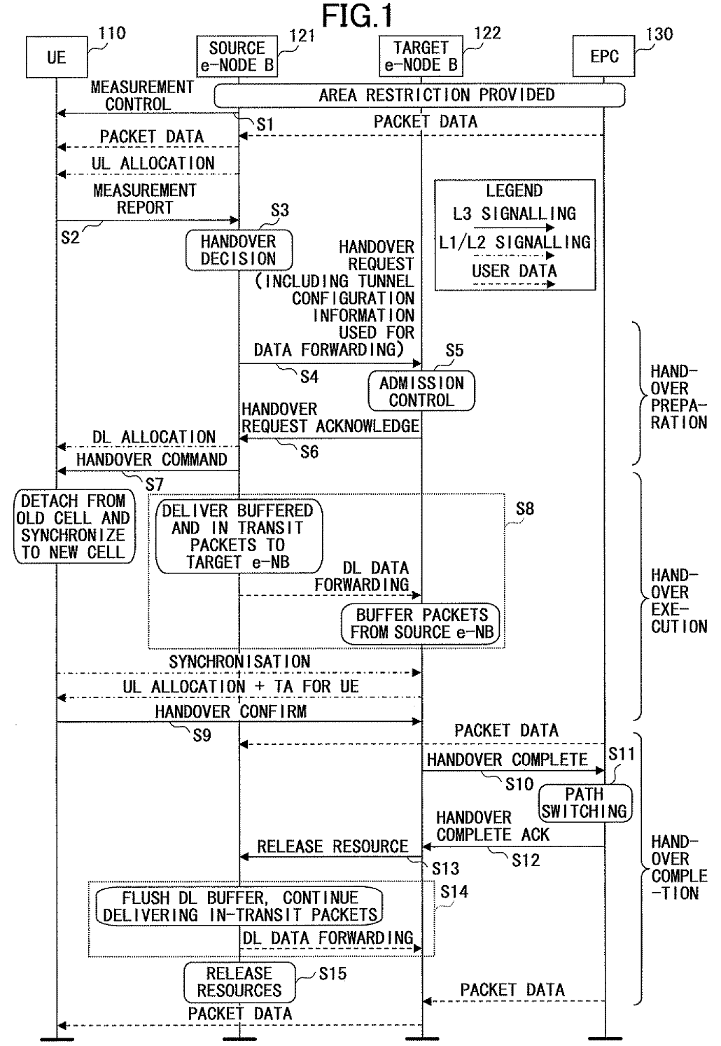

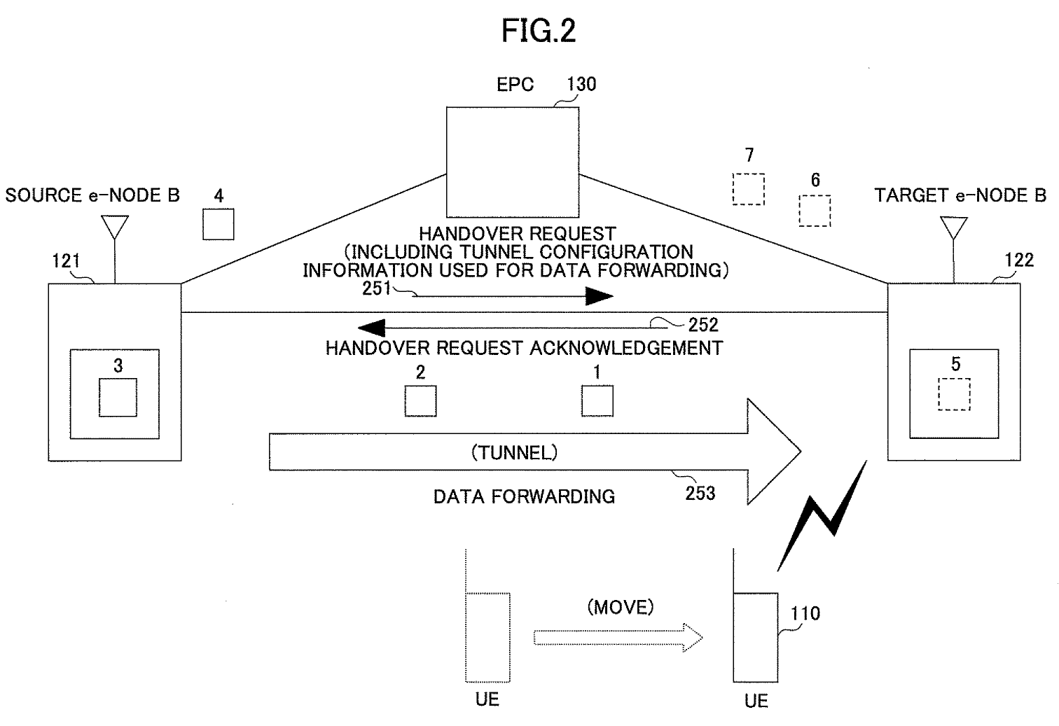

The user terminal 110 and the core network apparatus 130 of FIG. 5 are the same as the user terminal 110 and the core network apparatus 130, respectively, of FIGS. 1 and 2. However, base stations 521 and 522 are the handover source base station and the handover destination base station, respectively, described with reference to FIGS. 3 and 4 according to one embodiment of the present disclosure.

The base station (Source e-Node B) 521 transmits a measurement control message (Measurement Control) to the user terminal (UE) 110 as an L3 signal (Step S1). At this point, packet data are transmitted from the core network apparatus (EPC, Evolved Packet Core) 130 to the user terminal 110 via the base station 521. The base station 521 transmits an up-link allocation message (UL Allocation) to the user terminal 110 as an L1/L2 signal so as to allocate an uplink channel. The user terminal 110 transmits a measurement report message (Measurement Report) to the base station 521 in order to report a signal communication condition of the user terminal 110.

The base station (Source e-Node B) 521 determines based on the communication condition reported by the user terminal 110 whether handover to another base station (Target e-Node B) 522 due to movement of the user terminal 110 is necessary. When the base station 521 determines that handover is necessary (Step S3), the handover source base station (Source e-Node B) 521 transmits a handover request message (in Step S54) to the base station (Target e-Node B) 522, which is a handover destination candidate.

At this point, since transfer delay is undesirable for the VoIP service being used by the user, the handover source base station (Source e-Node B) 521 determines that data forwarding is unnecessary. The handover source base station 521 includes, in a handover request message (Handover Request), information indicating that “no data forwarding is to be performed”, and transmits the handover request message to the base station 522, which is a handover destination candidate.

By receiving the handover request message (information indicating “no data forwarding is to be performed”), the base station 522, which is a handover destination candidate, learns that no data forwarding is to be performed.

The base station 522 becomes a handover destination base station by performing call admission control (Admission Control) (Step S5) and sending a handover request acknowledge message (Handover Request Acknowledge) back to the handover source base station 521 (Step S6).

On receiving the handover request acknowledge message from the handover destination base station 522 (Step S6), the handover source base station 521 sends a down-link allocation message (DL Allocation) to the user terminal 110 as an L1/L2 signal and then transmits a handover command message (Handover Command) to the user terminal 110 so that the user terminal 110 performs communications in sync with the handover destination base station 522 (Step S7).

In the conventional handover procedure, data forwarding from the handover source base station to the handover destination base station is performed in Steps S8 and S14 as illustrated in FIG. 1. However, the handover source base station 521 determines not to perform data forwarding, and reports the determination to the handover destination base station 522 by including, in the handover request message (in Step S54), the information indicating that “no data forwarding is to be performed”. As a result, data forwarding corresponding to Steps S8 and S14 of FIG. 1 is not performed.

When receiving a handover request acknowledge message from the handover destination base station 522, the handover source base station 521 instructs the user terminal 110 to perform a synchronization process with the handover destination base station. Subsequently, the handover source base station 521 deletes packet data that have been transmitted from the higher-level core network apparatus 130 but have yet to be transferred to the user terminal 110. Packet data in the buffer are also deleted.

The user terminal 110 synchronizes with the handover destination base station 522 based on the L1/L2 signal (Synchronization), and receives an up-link allocation message (UL Allocation) and a timing advance message (Timing Advance). Upon becoming ready to receive the packet data from the handover destination base station 522, the user terminal 110 transmits a handover confirmation message (Handover Confirm) to the handover destination base station 522 (Step S9). At this point, since the core network apparatus 130 does not know that the user terminal 110 has been handed over to the handover destination base station 522, packet data directed to the user terminal 110 are still being transmitted to the handover source base station 521.

After receiving the handover confirm message from the user terminal 110 (Step S9), the handover destination base station 522 transmits a handover completion message (Handover Complete) to the higher-level core network apparatus 130 so as to report to the core network apparatus 130 that the user terminal 110 has come to belong to the handover destination base station 522 (Step S10).

In response, the core network apparatus 130 switches a communications path (Step S11) so as to change the transmission destination of the packet data directed to the user terminal 110 from the handover source base station 521 to the handover destination base station 522. The core network apparatus 130 transmits a handover completion acknowledgement message (Handover Complete Acknowledge) to the handover destination base station 522, thereby reporting to the handover destination base station 522 that communications path switching is completed. In response, the handover destination base station 522 transmits a release resource message (Release Resource) to the handover source base station 521 (Step S13) so that the handover source base station 521 releases resources allocated for the user terminal 110.

At this point, even if the handover source base station 521 still has packet data directed to the user terminal 110, the handover source base station 521 does not forward the packet data to the handover destination base station 522. That is, the data forwarding in Step S14 of FIG. 1 is not performed.

After the communications path switching (Step S11), packet data directed to the user terminal 110 are transmitted to the user terminal 110 from the core network apparatus 130 via the handover destination base station 522.

Knowing in advance that no data are to be forwarded from the handover source base station 521, the handover destination base station 522 is able to transmit packet data directed to the user terminal 110 as soon as the packet data are directly transmitted from the core network apparatus 130.

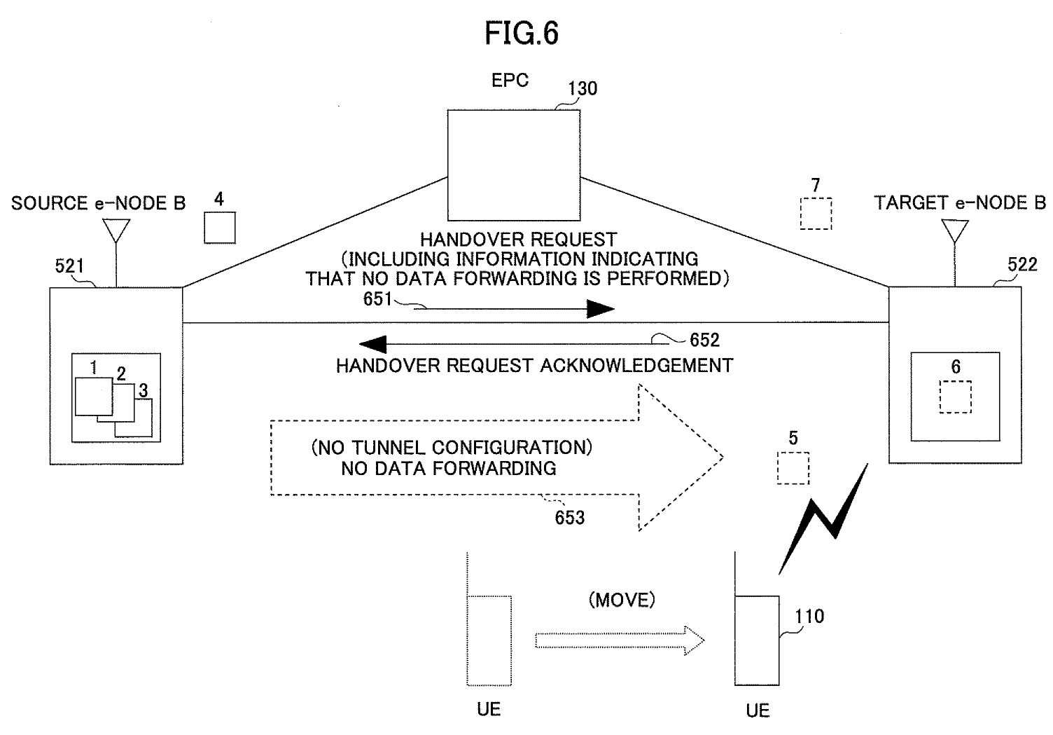

FIG. 6 illustrates in further detail the packet data transfer of FIG. 5 according to the first embodiment of the present disclosure. The user terminal (UE) 110, the handover source base station (Source e-Node B) 521, the handover destination base station (Target e-Node B) 522, and the core network apparatus (EPC) 130 of FIG. 6 correspond to the user terminal (UE) 110, the handover source base station (Source e-Node B) 521, the handover destination base station (Target e-Node B) 522, and the core network apparatus (EPC) 130 of FIG. 5, respectively.

As the user terminal 110 moves, the user terminal 110 is handed over from the handover source base station 521 to the handover destination base station 522. At this point, the handover source base station 521 transmits a handover request message (Handover Request) 651 to the handover destination base station 522 (Step S54 of FIG. 5). The handover destination base station (Target e-Node B) 522 sends back a handover request acknowledge (Handover Request Acknowledge) message 652 to the handover source base station 521 (Step S6 of FIG. 5).

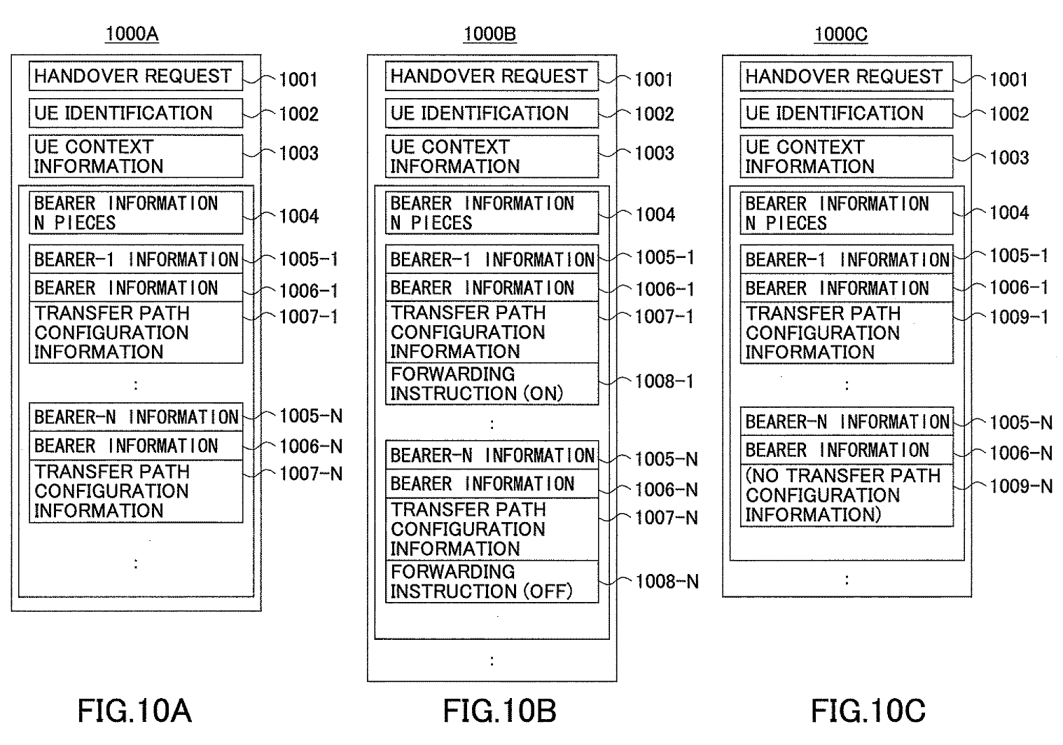

The handover request message 651 includes information indicating that “no data forwarding is performed” (forwarding instruction (ON/OFF) of FIG. 10B). By checking the information, the handover destination base station 522 learns that data forwarding, which requires configuration of a tunnel between the handover source base station 521 and the handover destination base station 522, is not to be performed (653 of FIG. 6).

The packet data (1 through 4), which have been transmitted to the handover source base station 521 from the core network apparatus 130 after implementation of handover is decided, are deleted by the handover source base station 521 without being forwarded to the handover destination base station 522.

After handover is implemented, the core network apparatus 130 switches a communications path (Step S11 of FIG. 5), and transmits subsequent packet data (5 through 7 of FIG. 6) to the handover destination base station 522.

Here, the numbers of the packet data (1 through 7) indicate the sequence of packet data transmitted from the core network apparatus 130 to the base station 521 or 522, and also indicate the sequence of packet data transmitted from the base station 521 or 522 to the user terminal 110.

Knowing that no data are to be forwarded from the handover source base station 521, the handover destination base station 522 is able to transmit the packet data 5 through 7 to the user terminal 110 as soon as receiving them from the core network apparatus 130.

Although, in the present embodiment, the information indicating that no data forwarding is to be performed is included in a handover request message, the information does not have to be included in the handover request message. The information may be transmitted from the handover source base station to the handover destination base station as a signal independent of the handover request message.

Sequence in the Case where Service Other than VoIP is Also in Use

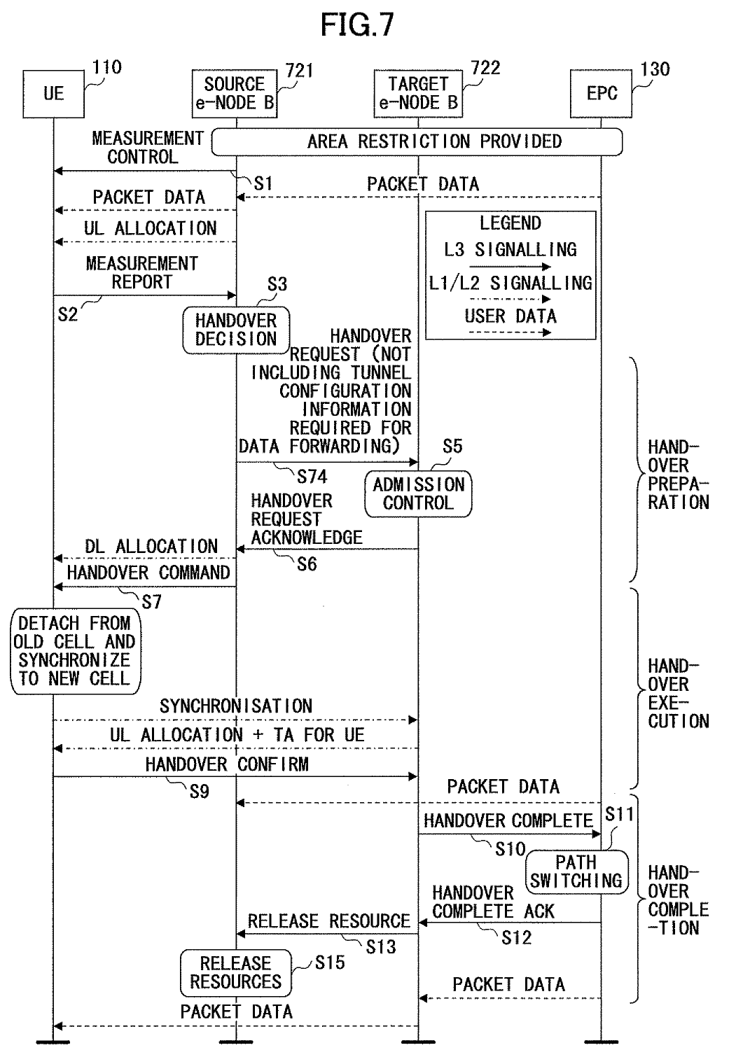

FIG. 7 is a sequence diagram illustrating a handover procedure carried out when no data forwarding is performed, according to another embodiment of the present disclosure.

In the present embodiment, a service in use is one for which transfer delay is undesirable.

The present embodiment differs from the embodiment illustrated in FIG. 5 in that a handover source base station 721 transmits to a handover destination base station 722 a handover request message (in Step S74) not including tunnel configuration information, which is required for data forwarding, when determining that no data forwarding is to be performed. However, the rest of the structure is the same as that of the embodiment of FIG. 5.

The handover destination base station 722 detects that the handover request message does not include the tunnel configuration information, thereby learning that data forwarding is not to be performed.

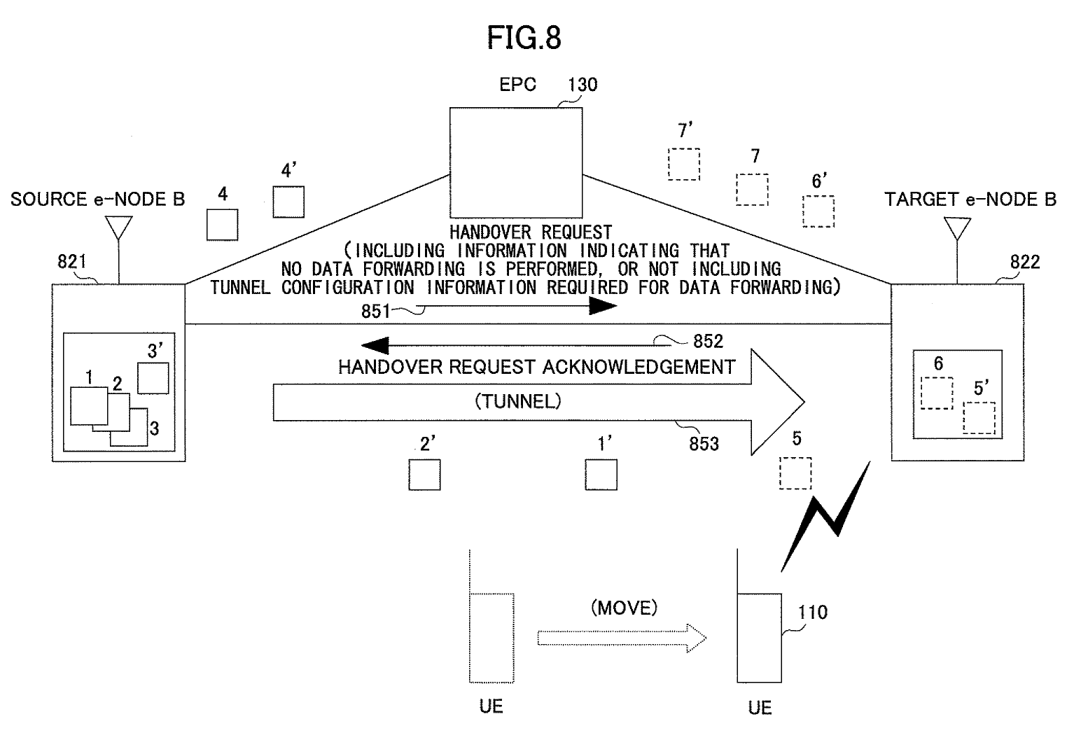

With reference to FIG. 8, next is described the case in which the user is using multiple services having different delay qualities. In this case, handover is performed while the user is simultaneously using the VoIP service, which is an application for which transfer delay is undesirable, and a video monitoring service, which is an application for which packet loss is less desirable than transfer delay.

The user terminal 110 moves from an area of a handover source base station 821 to an area of an adjacent handover destination base station 822 while concurrently receiving packet data (1 through 7) of the VoIP service and packet data (1′ through 7′) of the video monitoring service. In accordance with the movement, the handover source base station 821 determines that data forwarding is unnecessary for the packet data of the VoIP service since transfer delay is undesirable for the VoIP service in use. On the other hand, the handover source base station 821 determines that data forwarding is necessary for the packet data of the video monitoring service since packet loss is less desirable than transfer delay for the video monitoring service.

The handover source base station 821 includes, in a handover request message 851, information indicating that data forwarding is not to be performed for the VoIP communication but data forwarding is to be performed for the video monitoring, and transmits the handover request message 851 to the handover destination base station 822.

By receiving the handover request message 851, the handover destination base station 822 learns that data forwarding is not to be performed only for the VoIP service. In response to the handover request message 851, the handover destination base station 822 transmits a handover request acknowledge message 852 to the handover source base station 821.

When receiving the handover request acknowledge message 852, the handover source base station 821 instructs the user terminal 110 to perform a synchronization process with the handover destination base station 822. Subsequently, the handover source base station 821 deletes the packet data (1 through 4) of the VoIP service directed to the user terminal 110, which packet data have been transmitted from the higher-level core network apparatus 130 after implementation of handover has been decided. Packet data in the buffer are also deleted.

With the handover request message 851, the handover destination base station 822 knows that data forwarding is not to be performed for the packet data of the VoIP service. Therefore, when directly receiving the packet data (5 through 7) of the VoIP service from the core network apparatus 130, the handover destination base station 822 is able to immediately transfer the packet data to the user terminal 110.

On the other hand, the handover source base station 821 forwards, to the handover destination base station 822 according to the conventionally specified method, the packet data (1′ through 4′) of the video monitoring service directed to the user terminal 110, which packet data have been transmitted from the higher-level core network apparatus 130 after implementation of handover has been decided.

With the handover request message 851, the handover destination base station 822 knows that data forwarding is to be performed for the packet data of the video monitoring service.

Therefore, when directly receiving the packet data (5′ through 7′) of the video monitoring service from the core network apparatus 130, the handover destination base station 822 does not immediately transmit the packet data to the user terminal 110. Instead, the handover destination base station 822 waits to receive the packet data (1′ through 4′) forwarded from the handover source base station 821, and transmits them first to the user terminal 110. Alternatively, the handover destination base station 822 determines the end timing of the data forwarding using an arbitrary method, and subsequently starts transferring the packets transmitted from the core network apparatus 130.

### Hardware Configuration

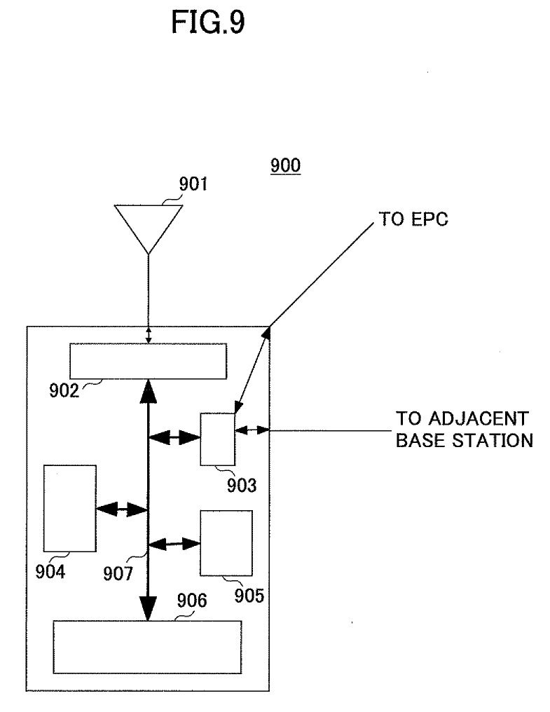

FIG. 9 is a block diagram showing the configuration of a base station according to one embodiment of the present disclosure. A base station 900 includes an antenna 901 which is a wireless communications interface with a user terminal (the user terminal 110 of FIGS. 5, 6, 7 and 8) and a wireless interface unit 902 for controlling the antenna 901. The base station 900 also includes a wired communications interface unit 903, which functions as a wired communications interface with a higher-level core network apparatus (the core network apparatus 130 of FIGS. 5, 6, 7 and 8) and an adjacent base station (the base station 522, 722 or 822 of FIGS. 5, 6, 7 and 8).

The base station 900 also includes a signal message control unit 904. The signal message control unit 904 performs signal processes—such as signal generation, detection, analysis, and conversion—on signals exchanged with the core network apparatus, other base stations and the user terminal via layers 1 through 3, and controls other components of the base station 900 based on the results of the signal processes. In particular, the signal message control unit 904 adds, to a handover request message, information (parameter) indicating that no data forwarding is to be performed, and deletes tunnel configuration information from the handover request message, thereby generating a desired message to be exchanged by the base station 900 with an adjacent base station.

The base station 900 further includes a packet data control unit 905 and a buffer 906. The packet data control unit 905 controls packet data to be exchanged between the core network apparatus and the user terminal. The packet data control unit 905 also controls data forwarding to a handover destination base station when the base station 900 is a handover source base station as well as data forwarding from a handover source base station when the base station 900 is a handover destination base station. In particular, the packet data control unit 905 analyzes packet data transmitted from the core network apparatus to the user terminal to determine whether the packet data are data related to a service for which transfer delay is undesirable, and controls accumulation or deletion of the packet data based on the determination result. The buffer 906 is a memory device for temporarily accumulating packet data received by the packet data control unit 905.

### Data Structure of Handover Request Message

FIGS. 10A through 10C show message structures of a handover request message (Handover Request) that a base station generates and transmits to an adjacent base station. FIG. 10A shows a handover request message of the conventional base station illustrated in FIG. 1, provided for the purpose of reference. FIG. 10B shows a handover request message related to the base station 521 of FIGS. 5 and 6 of one embodiment of the present disclosure. FIG. 10C shows a handover request message related to the base station 721 of FIG. 7 of another embodiment of the present disclosure.

A handover request message 1000A of FIG. 10A includes information 1001 indicating that the message is a handover request message; user terminal (UE) identification information 1002; and user terminal context information 1003.

In the case where the user terminal is using multiple services (N services), the handover request message 1000A includes N pieces of Bearer information 1004 corresponding one-to-one with the services. The handover request message 1000A further includes, for each piece of Bearer information, information items 1005-1 through 1005-N indicating the Bearer number; Bearer information items 1006-1 through 1006-N including an IP address, a port number, a Bearer type, a codec type and the like; and transfer path configuration information items 1007-1 through 1007-N.

A handover request message 1000B of FIG. 10B is the handover request message (in Step S54) related to the base station 521 of the embodiment illustrated in FIGS. 5 and 6. The handover request message 1000B differs from the handover request message 1001A of FIG. 10A in including information 1008-1 indicating that data forwarding for Bearer 1 is to be performed (ON) and information 1008-N indicating that data forwarding for Bearer N is not to be performed (OFF). By detecting the information items 1008-1 through 1008-N, the handover destination base station learns whether data forwarding is to be performed for each Bearer.

A handover request message 1000C of FIG. 10C is the handover request message (in Step S74) related to the base station 721 of the embodiment illustrated in FIG. 7. The handover request message 1000C differs from the handover request message 1000A of FIG. 10A in that Bearer 1 includes tunnel configuration information (transfer path configuration information) 1009-1 required for data forwarding and that Bearer N does not include tunnel configuration information (transfer path configuration information) 1009-N. By detecting (or not detecting) the tunnel configuration information (transfer path configuration information) items 1009-1 through 1009-N, the handover destination base station learns whether data forwarding is to be performed for each Bearer.

Thus, the handover request messages 1000B and 1000C illustrated in FIGS. 10B and 10C include a Bearer for each service so as to deal with the case where the user terminal is using multiple services, whereby parameter control can be performed so that the necessity or the lack of necessity of packet transfer is indicated for each service.

### Second Embodiment

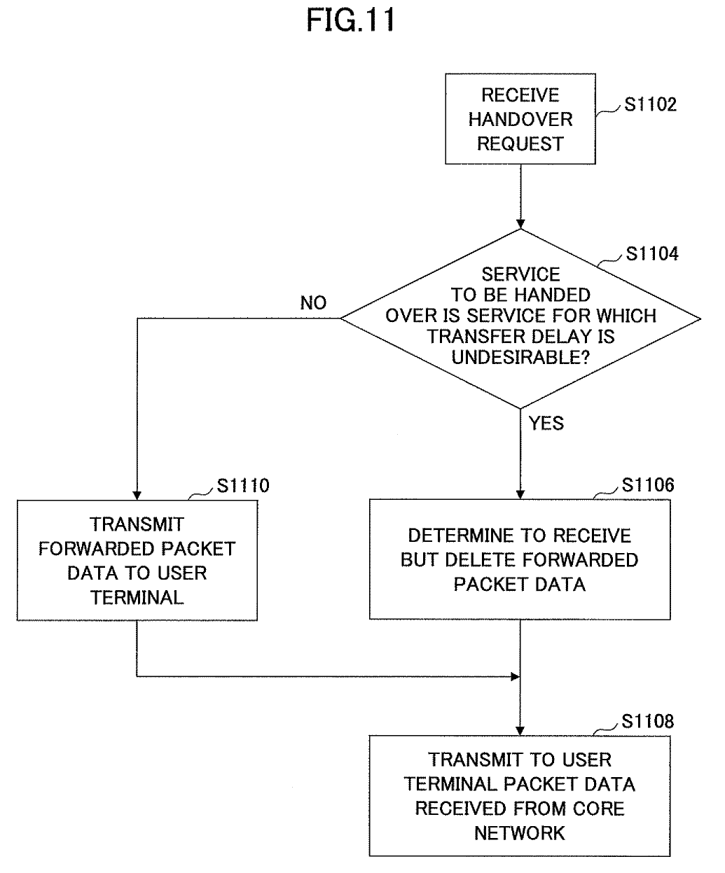

With reference to FIG. 11, next is described the operation of a base station according to the second embodiment of the present disclosure. FIG. 11 is a flowchart illustrating the operation of a handover destination base station according to the second embodiment of the present disclosure.

On receiving a handover request message (Step S1102), the handover destination base station of the present embodiment determines, based on the handover request message, what service is to be handed over and whether transfer delay is undesirable for the service (Step S1104). If determining that the service to be handed over is a service for which transfer delay is undesirable (YES in Step S1104), the handover destination base station determines to receive forwarded data as in the conventional technique but delete the forwarded packet data (Step S1106). With the determination, the handover destination base station is able to transmit, to the user terminal, packet data received from the core network apparatus without waiting for data forwarding of packet data that the handover source base station has already received but has yet to transfer to the user terminal (Step S1108).

On the other hand, if determining that the service to be handed over is not a service for which transfer delay is undesirable (NO in Step S1104), the handover destination base station first transmits, to the user terminal, packet data forwarded from the handover source base station as in the conventional technique (Step S1110), and then transmits to the user terminal packet data received from the core network apparatus (Step S1108). Herewith, in the case where the service to be handed over is not a service for which transfer delay is undesirable (that is, a service for which packet loss is less desirable than transfer delay), it is possible not to lose packet data forwarded from the handover source base station and to transfer the forwarded packet data before packet data received from the core network apparatus.

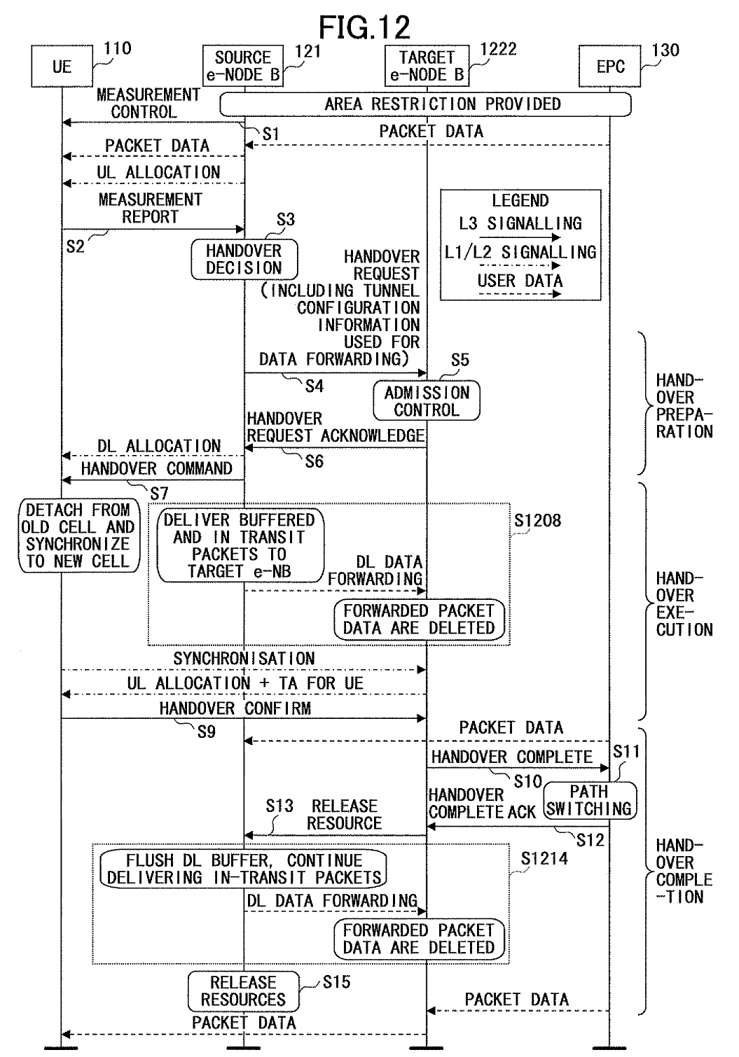

FIG. 12 is a sequence diagram illustrating a handover procedure carried out when no data forwarding is performed, according to the second embodiment of the present disclosure.

The user terminal 110, the base station 121 and the core network apparatus 130 of FIG. 12 are the same as the user terminal 110, the base station 121 and the core network apparatus 130, respectively, of FIGS. 1 and 2. However, a base station 1222 is the handover destination base station of FIG. 12 according to the second embodiment of the present disclosure.

The base station (Source e-Node B) 121 transmits a measurement control message (Measurement Control) to the user terminal (UE) 110 as an L3 signal (Step S1). At this point, packet data are transmitted from the core network apparatus (EPC, Evolved Packet Core) 130 to the user terminal 110 via the base station 121. The base station 121 transmits an up-link allocation message (UL Allocation) to the user terminal 110 as an L1/L2 signal so as to allocate an uplink channel. The user terminal 110 transmits a measurement report message (Measurement Report) to the base station 121 in order to report a signal communication condition of the user terminal 110.

The base station (Source e-Node B) 121 determines based on the communication condition reported by the user terminal 110 whether handover to another base station (Target e-Node B) 1222 due to movement of the user terminal 110 is necessary. When the base station 121 determines that handover is necessary (Step S3), the handover source base station (Source e-Node B) 121 transmits a handover request message to the base station (Target e-Node B) 1222, which is a handover destination candidate (Step S4). The handover request message is the conventional handover request message described with reference to FIGS. 1 and 2.

The base station 1222, which is a handover destination candidate, receives the handover request, thereby being able to determine what service is to be handed over and whether the service is a service for which transfer delay is undesirable.

The base station 1222 becomes a handover destination base station by performing call admission control (Admission Control) (Step S5) and sending a handover request acknowledge message (Handover Request Acknowledge) back to the handover source base station 121 (Step S6).

On receiving the handover request acknowledge message from the handover destination base station 1222 (Step S6), the handover source base station 121 sends a down-link allocation message (DL Allocation) to the user terminal 110 as an L1/L2 signal and then transmits a handover command message (Handover Command) to the user terminal 110 so that the user terminal 110 performs communications in sync with the handover destination base station 1222 (Step S7).

According to the handover procedure of the present embodiment, in Step S1208 after Step S7, data forwarding from the handover source base station 121 to the handover destination base station 1222 is performed, as in Steps 8 and 14 of FIG. 1. However, since determining to receive but delete forwarded packet data (Step S1106 of FIG. 11), the handover destination base station 1222 deletes the forwarded packet data.

The user terminal 110 synchronizes with the handover destination base station 1222 based on the L1/L2 signal (Synchronization), and receives an up-link allocation message (UL Allocation) and a timing advance message (Timing Advance). Upon becoming ready to receive the packet data from the handover destination base station 1222, the user terminal 110 transmits a handover confirmation message (Handover Confirm) to the handover destination base station 1222 (Step S9). At this point, since the core network apparatus 130 does not know that the user terminal 110 has been handed over to the handover destination base station 1222, packet data directed to the user terminal 110 are still being transmitted to the handover source base station 121.

After receiving the handover confirm message from the user terminal 110 (Step S9), the handover destination base station 1222 transmits a handover completion message (Handover Complete) to the higher-level core network apparatus 130 so as to report to the core network apparatus 130 that the user terminal 110 has come to belong to the handover destination base station 1222 (Step S10).

In response, the core network apparatus 130 switches a communications path (Step S11) so as to change the transmission destination of the packet data directed to the user terminal 110 from the handover source base station 121 to the handover destination base station 1222. The core network apparatus 130 transmits a handover completion acknowledgement message (Handover Complete Acknowledge) to the handover destination base station 1222, thereby reporting to the handover destination base station 1222 that communications path switching is completed. In response, the handover destination base station 1222 transmits a release resource message (Release Resource) to the handover source base station 121 (Step S13) so that the handover source base station 121 releases resources allocated for the user terminal 110.

In Step S1214 after Step S13, if still holding packet data directed to the user terminal 110, the handover source base station 121 forwards the packet data to the handover destination base station 1222. However, as in Step S1208, the handover destination base station 1222 deletes the forwarded packet data since determining to receive but delete the forwarded packet data (Step S1106 of FIG. 11).

After the communications path switching (Step S11), packet data directed to the user terminal 110 are transmitted to the user terminal 110 from the core network apparatus 130 via the handover destination base station 1222.

Since determining to receive but delete packet data forwarded from the handover source base station 121, the handover destination base station 1222 is able to transmit packet data directed to the user terminal 110 as soon as the packet data are directly transmitted from the core network apparatus 130.

In conclusion, according to one aspect of the present disclosure, for a service for which transfer delay is undesirable, it is possible to report from the handover source base station to the handover destination base station that no data forwarding is to be performed. This eliminates the necessity of the tunnel configuration procedure for data forwarding. As a result, as soon as packets have arrived from the higher-level core network apparatus, the handover destination base station is able to transfer the packets to the user terminal, thus reducing transfer delay.

Thus, the embodiments of the present disclosure have been described in detail; however, it should be understood that the present invention is not limited to the particular embodiments and various changes and modification may be made to the particular embodiments without departing from the broad scope of the present invention as defined in the appended claims.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority or inferiority of the invention. Although the embodiments of the present disclosure have been described in detail, it should be understood that various changes, substitutions, and alterations could be made hereto without departing from the spirit and scope of the invention.

What is claimed is:

1. A base station for transferring, to a user terminal, a series of packet data received from a higher-level network, the base station comprising:
a determining unit configured to, when the user terminal is handed over to a handover destination base station due to movement of the user terminal, determine according to a transfer delay-related characteristic of the series of packet data whether data forwarding of the series of the packet data to the handover destination base station is not to be performed.

2. The base station as claimed in claim 1, further comprising a reporting unit configured to, in a case where the determining unit determines that the data forwarding is not to be performed, report to the handover destination base station that the data forwarding is not to be performed.

3. The base station as claimed in claim 2, wherein the reporting unit achieves the reporting by including, in a handover request, information indicating that the data forwarding is not to be performed.

4. The base station as claimed in claim 2, wherein the reporting unit achieves the reporting by not including, in a handover request, information necessary for the data forwarding.

5. The base station as claimed in claim 2, further comprising a deleting unit configured to, in the case where the determining unit determines that the data forwarding is not to be performed, delete packet data that have been received from the higher-level network but have yet to be transmitted to the user terminal.

6. The base station as claimed in claim 1, wherein in a case where the base station is transmitting, to the user terminal, another series of packet data received from the higher-level network while transmitting the series of the packet data to the user terminal, the determining unit determines according to a transfer delay-related characteristic of the other series of packet data that data forwarding for the other series of packet data is to be performed when the user terminal is handed over to the handover destination base station due to movement of the user terminal.

7. The base station as claimed in claim 1, further comprising a packet data transfer unit configured to, if the determining unit determines that data forwarding from a handover source base station is not to be performed, transfer to the user terminal packet data received from the higher-level network without waiting for the data forwarding from the handover source base station.

8. The base station as claimed in claim 7 further comprising a deleting unit configured to delete packet data forwarded from the handover source base station.

9. A base station for transferring, to a user terminal, a series of packet data received from a higher-level network, the base station comprising:
a report receiving unit configured to, when the user terminal is handed over to the base station from a handover source base station due to movement of the user terminal, receive a report that data forwarding from the handover source base station is not to be performed; and
a packet data transfer unit configured to, according to the received report, transfer to the user terminal the series of the packet data received from the higher-level network without waiting for the data forwarding.

10. A packet data transfer method applied to a handover source base station and a handover destination base station that transfer, to a user terminal, a series of packet data received from a higher-level network, the packet data transfer method comprising:
determining, due to movement of the user terminal, to hand over the user terminal from the handover source base station to the handover destination base station;
determining, in the handover source base station or the handover destination base station, whether data forwarding from the handover source base station to the handover destination base station is not to be performed, according to a transfer delay-related characteristic of the series of packet data;
in a case of determining in the handover source base station that the data forwarding is not to be performed, reporting the determination from the handover source base station to the handover destination base station; and
according to the determination, transferring, from the handover destination base station to the user terminal, packet data received from the higher-level network without waiting for the data forwarding.
